(19) United States
(12) Patent Application Publication
(10) Pub. No.: US 2026/0105931 A1
(43) Pub. Date: Apr. 16, 2026

(54) MAGNETIC HEAD AND MAGNETIC RECORDING DEVICE

(71) Applicant: KABUSHIKI KAISHA TOSHIBA, Tokyo (JP)

(72) Inventors: Satoshi SHIROTORI, Yokohama Kanagawa (JP); Yuji NAKAGAWA, Kawasaki Kanagawa (JP); Tazumi NAGASAWA, Yokohama Kanagawa (JP)

(73) Assignee: KABUSHIKI KAISHA TOSHIBA, Tokyo (JP)

(21) Appl. No.: 19/246,878

(22) Filed: Jun. 24, 2025

(30) Foreign Application Priority Data
Oct. 16, 2024 (JP) 2024-180953

(51) Int. Cl. G11B 5/11

(52) U.S. Cl. CPC G11B 5/11

(57) ABSTRACT

According to one embodiment, a magnetic head includes first and second shields, a first non-magnetic layer, first to fourth magnetic layers, and a first intermediate layer. The first non-magnetic layer includes a first partial region and a second partial region. A second direction from the first partial region to the second partial region crosses a first direction from the first shield to the second shield. The first partial region is provided between the first shield and the second shield in the first direction. The first magnetic layer is provided between the first shield and the first partial region in the first direction. The second magnetic layer is provided between the first partial region and the second shield in the first direction. The fourth magnetic layer is provided between the second partial region and the third magnetic layer.

### CROSS-REFERENCE TO RELATED APPLICATIONS

This application is based upon and claims the benefit of priority from Japanese Patent Application No. 2024-180953, filed on Oct. 16, 2024; the entire contents of which are incorporated herein by reference.

### FIELD

Embodiments described herein relate generally to a magnetic head and a magnetic recording device.

### BACKGROUND

Information recorded on a magnetic recording medium is reproduced by using a magnetic head including a magnetic layer. It is desirable to improve the characteristics of the magnetic head.

### BRIEF DESCRIPTION OF THE DRAWINGS

FIGS. 1A and 1B are schematic views illustrating a magnetic head according to a first embodiment;

FIG. 2 is a schematic transparent plan view illustrating the magnetic head according to the first embodiment;

FIG. 3 is a schematic cross-sectional view illustrating a magnetic head according to the first embodiment;

FIG. 4 is a schematic transparent plan view illustrating a magnetic head according to the first embodiment;

FIG. 5 is a schematic cross-sectional view illustrating a magnetic head according to the first embodiment;

FIG. 6 is a schematic cross-sectional view illustrating a magnetic head according to the first embodiment;

FIG. 7 is a schematic cross-sectional view illustrating a magnetic head according to the first embodiment;

FIG. 8 is a schematic perspective view illustrating the magnetic head and magnetic recording device according to a second embodiment;

FIG. 9 is a schematic perspective view illustrating a part of the magnetic recording device according to the embodiment;

FIG. 10 is a schematic perspective view illustrating the magnetic recording device according to the embodiment; and

FIGS. 11A and 11B are schematic perspective views illustrating a part of the magnetic recording device according to the embodiment.

### DETAILED DESCRIPTION

According to one embodiment, a magnetic head includes a reproducing section. The reproducing section includes a first shield, a second shield, a first non-magnetic layer, a first magnetic layer, a second magnetic layer, a third magnetic layer, a fourth magnetic layer, and a first intermediate layer. The first non-magnetic layer includes a first partial region and a second partial region. A second direction from the first partial region to the second partial region crosses a first direction from the first shield to the second shield. The first partial region is provided between the first shield and the second shield in the first direction. The first magnetic layer is provided between the first shield and the first partial region in the first direction. The second magnetic layer is provided between the first partial region and the second shield in the first direction. The fourth magnetic layer is provided between the second partial region and the third magnetic layer. The first intermediate layer is provided between the third magnetic layer and the fourth magnetic layer. The first intermediate layer is non-magnetic.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### FIRST EMBODIMENT

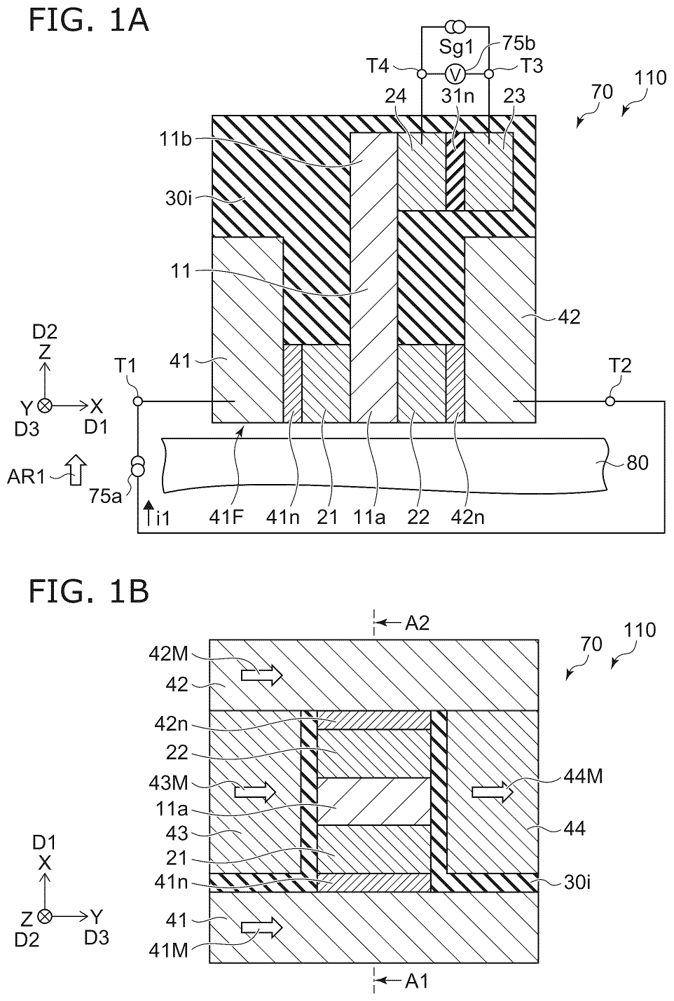

FIGS. 1A and 1B are schematic views illustrating a magnetic head according to a first embodiment.

FIG. 2 is a schematic transparent plan view illustrating the magnetic head according to the first embodiment.

FIG. 1A is a cross-sectional view taken along line the 1-A2 in FIG. 1B. FIG. 1B is a plan view viewed along arrow the AR1 in FIG. 1A.

As shown in FIGS. 1A, 1B and 2, a magnetic head 110 according to the embodiment includes a reproducing section 70. The reproducing section 70 includes a first shield 41, a second shield 42, a first non-magnetic layer 11, a first magnetic layer 21, a second magnetic layer 22, a third magnetic layer 23, a fourth magnetic layer 24 and a first intermediate layer 31n.

The first non-magnetic layer 11 includes a first partial region 11a and a second partial region 11b. A second direction D2 from the first partial region 11a to the second partial region 11b crosses a first direction D1 from the first shield 41 to the second shield 42.

The first direction D1 is defined as an X-axis direction. One direction perpendicular to the X-axis direction is defined as a Z-axis direction. A direction perpendicular to the X-axis direction and the Z-axis direction is defined as a Y-axis direction. The second direction D2 may be, for example, the Z-axis direction.

The first partial region 11a is provided between the first shield 41 and the second shield 42 in the first direction D1. The first non-magnetic layer 11 may include, for example, at least one selected from the group consisting of Al, Cu, and Au.

The first magnetic layer 21 is provided between the first shield 41 and the first partial region 11a in the first direction D1. The second magnetic layer 22 is provided between the first partial region 11a and the second shield 42 in the first direction D1.

The fourth magnetic layer 24 is provided between the second partial region 11b and the third magnetic layer 23. The first intermediate layer 31n is provided between the third magnetic layer 23 and the fourth magnetic layer 24. The first intermediate layer 31n is non-magnetic. In this example, the direction from the second partial region 11b to the third magnetic layer 23 is along the first direction D1.

As shown in FIG. 1A, the first shield 41 includes a first face 41F. The first face 41F is configured to face the magnetic recording medium 80. The first face 41F corresponds to a medium facing face.

The Z-axis direction corresponds to a height direction, for example. The X-axis direction is along a down-track direction, for example. The Y-axis direction is along a cross-track direction, for example.

As shown in FIG. 1A, the reproducing section 70 may include a first terminal T1, a second terminal T2, a third terminal T3, and a fourth terminal T4. The first terminal T1 is electrically connected to the first shield 41. The second terminal T2 is electrically connected to the second shield 42. The third terminal T3 is electrically connected to the third magnetic layer 23. The fourth terminal T4 is electrically connected to the fourth magnetic layer 24.

For example, a first current i1 is supplied between the first terminal T1 and the second terminal T2. In this state, a first signal Sg1 between the third terminal T3 and the fourth terminal T4 is configured to change according to the state of the magnetic recording medium 80. The first signal Sg1 changes according to the information recorded on the magnetic recording medium 80. By detecting the first signal Sg1, the information recorded on the magnetic recording medium 80 can be reproduced.

In the embodiment, the first magnetic layer 21 and the second magnetic layer 22 face the magnetic recording medium 80. The magnetization of each of the first magnetic layer 21 and the second magnetic layer 22 changes in response to a magnetic field from the magnetic recording medium 80. The first magnetic layer 21 and the second magnetic layer 22 operate differentially.

For example, the magnetic recording medium 80 may be a perpendicular recording medium. For example, when the magnetization direction of the magnetic recording medium 80 changes, the magnetization of each of the first magnetic layer 21 and the second magnetic layer 22 changes, and the change acts on the magnetization of the fourth magnetic layer 24. This causes the first signal Sg1 to change. It is considered that the change in the first signal Sg1 corresponds to a change in the angle between the magnetization of the fourth magnetic layer 24 and the magnetization of the third magnetic layer 23. The third magnetic layer 23 functions as, for example, a reference layer.

In the embodiment, the state of the magnetic recording medium 80 can be detected with high sensitivity by the first signal Sg1. A magnetic head capable of improving characteristics is provided.

For example, in a magnetization transition region of the magnetic recording medium 80, the region of upward magnetization is aligned with the region of downward magnetization. In the magnetization transition region of the magnetic recording medium 80, the magnetization of the first magnetic layer 21 is upward and the magnetization of the second magnetic layer 22 is downward. In this state, the first current i1 is supplied. As a result, the transmitted upward spins corresponding to the upward magnetization of the first magnetic layer 21 are injected into the first partial region 11a of the first non-magnetic layer 11. Furthermore, the reflected upward spins corresponding to the downward magnetization of the second magnetic layer 22 are injected into the first partial region 11a of the first non-magnetic layer 11. These injected spins (spin currents) are diffused to the second partial region 11b and act on the fourth magnetic layer 24. It is considered that this causes a change in the magnetization of the fourth magnetic layer 24.

For example, in the magnetic recording medium 80, there are a first magnetization transition region and a second magnetization transition region. In the first magnetization transition region, the magnetization of the magnetic recording medium 80 transitions from a region where the magnetization of the magnetic recording medium 80 is downward to a region where the magnetization of the magnetic recording medium 80 is upward. In the second magnetization transition region, the magnetization of the magnetic recording medium 80 transitions from a region where the magnetization of the magnetic recording medium 80 is upward to a region where the magnetization of the magnetic recording medium 80 is downward. The direction of the spin current injected in the first magnetization transition region is different from the direction of the spin current injected in the second magnetization transition region. The effect on the magnetization of the fourth magnetic layer 24 changes depending on the direction of the injected spin. As a result, the electrical resistance between the fourth magnetic layer 24 and the third magnetic layer 23 changes.

In a continuous magnetization region in the magnetic recording medium 80, downward magnetization or upward magnetization continues. In the continuous magnetization region, the direction of magnetization of the first magnetic layer 21 is the same as the direction of magnetization of the second magnetic layer 22. In a case where the first current i1 is supplied to the continuous magnetization region, spins of opposite directions are injected into the first partial region 11a of the first non-magnetic layer 11, and there is no effect on the magnetization of the fourth magnetic layer 24.

In the embodiment, as described above, the electrical resistance changes in the magnetization transition region of the magnetic recording medium 80 depending on the magnetization states of the first magnetic layer 21 and the second magnetic layer 22. A differential operation is applied in the magnetization transition region. This provides high sensitivity. High resolution can be obtained.

As shown in FIG. 1A, in this example, at least a part of the fourth magnetic layer 24 overlaps the second magnetic layer 22 in the second direction D2. As described later, at least a part of the fourth magnetic layer 24 may overlap the first magnetic layer 21 in the second direction D2.

As shown in FIG. 1A, in this example, at least a part of the third magnetic layer 23 overlaps the second shield 42 in the second direction D2. As described later, at least a part of the third magnetic layer 23 may overlap the first shield 41 in the second direction D2.

As shown in FIGS. 1B and 2, the reproducing section 70 may further include a third shield 43 and a fourth shield 44. A third direction D3 from the third shield 43 to the fourth shield 44 crosses a plane including the first direction D1 and the second direction D2. The third direction D3 is, for example, the Y-axis direction.

The first magnetic layer 21, the first partial region 11a and the second magnetic layer 22 may be provided between the third shield 43 and the fourth shield 44 in the third direction D3. The third shield 43 and the fourth shield 44 correspond to, for example, side shields.

As shown in FIG. 2, in this example, a part of the second partial region 11b overlaps the third shield 43 in the second direction D2. Another part of the second partial region 11b overlaps the fourth shield 44 in the second direction D2.

A part of the third magnetic layer 23 and a part of the fourth magnetic layer 24 may overlap the third shield 43 in the second direction D2. Another part of the third magnetic layer 23 and another part of the fourth magnetic layer 24 may overlap the fourth shield 44 in the second direction D2.

With this configuration, a large area can be obtained in each of the second partial region 11b, the third magnetic layer 23, and the fourth magnetic layer 24. Higher sensitivity can be obtained.

As shown in FIG. 1B, a third shield magnetization 43M of the third shield 43 may be along a direction from the third shield 43 to the fourth shield 44. A fourth shield magnetization 44M of the fourth shield 44 may be along the direction from the third shield 43 to the fourth shield 44.

As shown in FIG. 1B, a first shield magnetization 41M of the first shield 41 may be along the direction from the third shield 43 to the fourth shield 44. The second shield magnetization 42M of the second shield 42 may be along the direction from the third shield 43 to the fourth shield 44.

In the embodiment, the first intermediate layer 31n may include MgO or Cu. For example, the fourth magnetic layer 24, the first intermediate layer 31n, and the third magnetic layer 23 may function as a TMR element. For example, the fourth magnetic layer 24, the first intermediate layer 31n, and the third magnetic layer 23 may function as a GMR element.

In the embodiment, at least one of the first magnetic layer 21 or the second magnetic layer 22 may include a Heusler alloy. Higher sensitivity is easily obtained. At least one of the first magnetic layer 21 or the second magnetic layer 22 may include at least one selected from the group consisting of, for example, Co₂MnAl, Co₂MnSi, Co₂MnGa, Co₂MnGe, Co₂Mn(Ge_{0.5}Ga_{0.5}), Co₂Fe(Ge_{0.5}Ga_{0.5}) and CoFeMnSi. Higher sensitivity is easily obtained.

As shown in FIG. 1A, the reproducing section 70 may further include a first intermediate film 41n. The first intermediate film 41n is provided between the first shield 41 and the first magnetic layer 21, and is non-magnetic. By providing the first intermediate film 41n, the magnetic coupling between the first shield 41 and the first magnetic layer 21 is broken. For example, a good quality crystal structure is easily obtained in the first magnetic layer 21.

The reproducing section 70 may further include a second intermediate film 42n. The second intermediate film 42n is provided between the second shield 42 and the second magnetic layer 22, and is non-magnetic. By providing the second intermediate film 42n, the magnetic coupling between the second shield 42 and the second magnetic layer 22 is broken. For example, a good quality crystal structure is easily obtained in the second magnetic layer 22.

As shown in FIGS. 1A, 1B and 2, the reproducing section 70 may include an insulating member 30i. The insulating member 30i may be provided, for example, between a part of the first non-magnetic layer 11 and the first shield 41, and between a part of the first non-magnetic layer 11 and the second shield 42. The insulating member 30i may be provided, for example, between the second magnetic layer 22 and the fourth magnetic layer 24.

As shown in FIG. 1B, a part of the insulating member 30i may be provided between the first shield 41 and the third shield 43. A part of the insulating member 30i may be provided between the first shield 41 and the fourth shield 44.

In the magnetic head 110, the third magnetic layer 23 may, for example, include at least one selected from the group consisting of Fe, Co, and Ni. The third magnetic layer 23 may further include B. The third magnetic layer 23 is, for example, a ferromagnetic layer.

The reproducing section 70 may further include an antiferromagnetic layer (not shown). The antiferromagnetic layer is connected to the third magnetic layer 23. By providing the antiferromagnetic layer, for example, unidirectional anisotropy may be imparted to the third magnetic layer 23. The antiferromagnetic layer may include at least one selected from the group consisting of IrMn and PtMn.

The fourth magnetic layer 24 may include, for example, at least one selected from the group consisting of Fe, Co, and Ni. The fourth magnetic layer 24 may further include B. The fourth magnetic layer 24 may include a Heusler alloy. The fourth magnetic layer 24 may include at least one selected from the group consisting of Co₂MnAl, Co₂MnSi, Co₂MnGa, Co₂MnGe, Co₂Mn(Ge_{0.5}Ga_{0.5}), Co₂Fe(Ge_{0.5}Ga_{0.5}), and CoFeMnSi. The fourth magnetic layer 24 is, for example, a ferromagnetic layer.

As shown in FIG. 1A, a first circuit 75a and a second circuit 75b may be provided. The first circuit 75a is electrically connected to the first terminal T1 and the second terminal T2. The first circuit 75a is configured to supply a first current i1 between the first terminal T1 and the second terminal T2. The second circuit 75b is electrically connected to the third terminal T3 and the fourth terminal T4. The second circuit 75b is configured to detect a first signal Sg1 between the third terminal T3 and the fourth terminal T4.

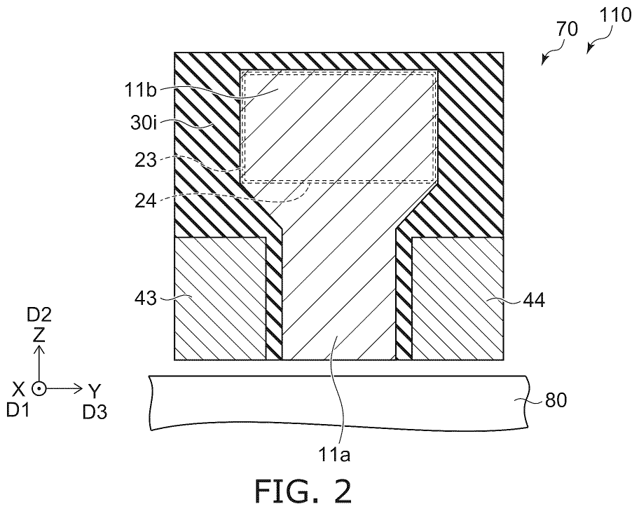

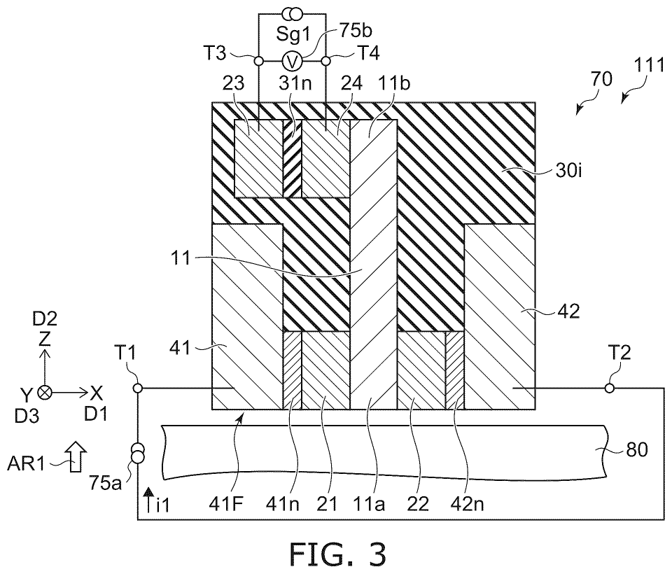

FIG. 3 is a schematic cross-sectional view illustrating a magnetic head according to the first embodiment.

FIG. 3 is a cross-sectional view corresponding to the line A1-A2 in FIG. 1B. As shown in FIG. 3, in a magnetic head 111 according to the embodiment, the positions of the third magnetic layer 23 and the fourth magnetic layer 24 differ from those in the magnetic head 110. Except for this, the configuration of the magnetic head 111 may be the same as the configuration of the magnetic head 110.

In the magnetic head 111, at least a part of the fourth magnetic layer 24 overlaps the first magnetic layer 21 in the second direction D2. At least a part of the third magnetic layer 23 overlaps the first shield 41 in the second direction D2. The magnetic head 111 is also capable of high sensitivity detection. High resolution is obtained. A magnetic head capable of improving characteristics is provided.

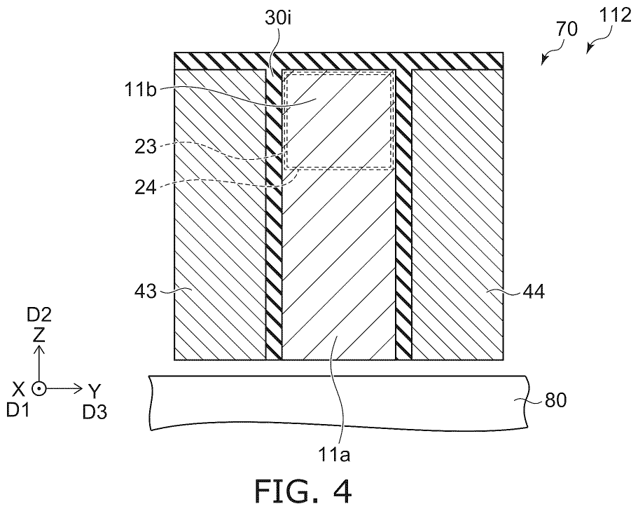

FIG. 4 is a schematic transparent plan view illustrating a magnetic head according to the first embodiment.

As shown in FIG. 4, in a magnetic head 112 according to the embodiment, the configuration of the first non-magnetic layer 11 differs from that in the magnetic head 110. Except for this, the configuration of the magnetic head 112 may be the same as the configuration of the magnetic head 110.

As shown in FIG. 4, in the magnetic head 112, at least a part of the second partial region 11b is between the third shield 43 and the fourth shield 44. At least a part of the third magnetic layer 23 may be between the third shield 43 and the fourth shield 44. At least a part of the fourth magnetic layer 24 may be between the third shield 43 and the fourth shield 44. For example, a high shielding effect is easily obtained. Stable operation is easily obtained.

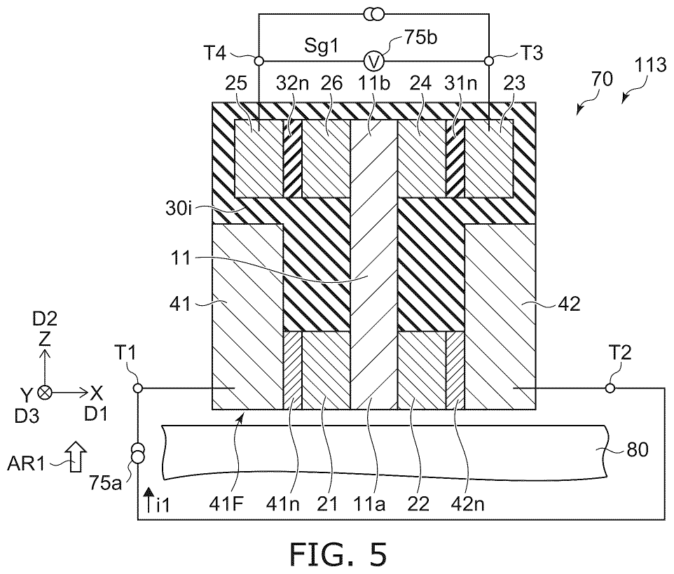

FIG. 5 is a schematic cross-sectional view illustrating a magnetic head according to the first embodiment.

FIG. 5 is a cross-sectional view corresponding to the line A1-A2 in FIG. 1B. As shown in FIG. 5, in the magnetic head 113 according to the embodiment, the reproducing section 70 further includes a fifth magnetic layer 25 and the like. Except for this, the configuration of the magnetic head 113 may be the same as the configuration of the magnetic head 110.

In the magnetic head 113, the reproducing section 70 further includes a fifth magnetic layer 25, a sixth magnetic layer 26, and a second intermediate layer 32n being non-magnetic. The second partial region 11b is between the fifth magnetic layer 25 and the third magnetic layer 23. The sixth magnetic layer 26 is between the fifth magnetic layer 25 and the second partial region 11b. The second intermediate layer 32n is between the fifth magnetic layer 25 and the sixth magnetic layer 26.

The reproducing section 70 may include the first terminal T1, the second terminal T2, the third terminal T3, and the fourth terminal T4. The first terminal T1 is electrically connected to the first shield 41. The second terminal T2 is electrically connected to the second shield 42. The third terminal T3 is electrically connected to the third magnetic layer 23. The fourth terminal T4 is electrically connected to the fifth magnetic layer 25.

As already explained, the first shield 41 includes the first face 41F configured to face the magnetic recording medium 80. The first signal Sg1 between the third terminal T3 and the fourth terminal T4 when the first current i1 flows between the first terminal T1 and the second terminal T2 is configured to change according to the state of the magnetic recording medium 80.

In the magnetic head 110, a first stack including the third magnetic layer 23, the first intermediate layer 31n, and the fourth magnetic layer 24, and a second stack including the fifth magnetic layer 25, the second intermediate layer 32n, and the sixth magnetic layer 26 are provided. These stacks provide the first signal Sg1 with higher intensity. Higher sensitivity is obtained. A higher signal-to-noise ratio is obtained.

In the magnetic head 110, the first circuit 75a and the second circuit 75b may be provided. The first circuit 75a is electrically connected to the first terminal T1 and the second terminal T2. The first circuit 75a is configured to supply a first current i1 between the first terminal T1 and the second terminal T2. The second circuit 75b is electrically connected to the third terminal T3 and the fourth terminal T4. The second circuit 75b is configured to detect the first signal Sg1 between the third terminal T3 and the fourth terminal T4.

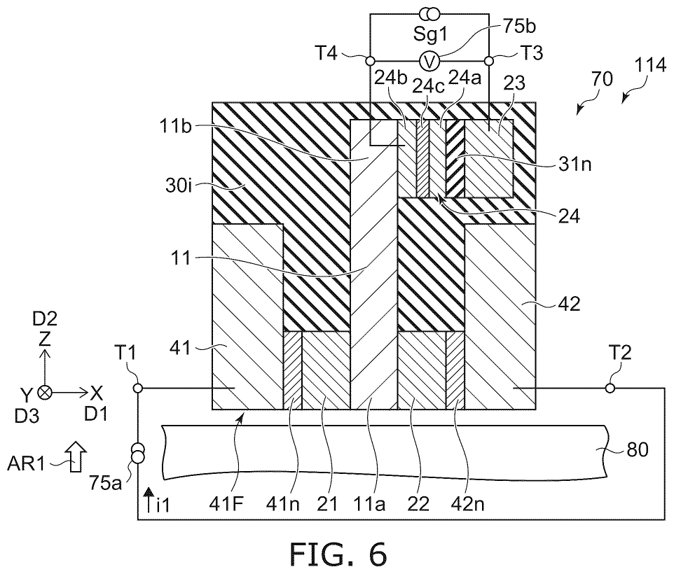

FIG. 6 is a schematic cross-sectional view illustrating a magnetic head according to the first embodiment.

FIG. 6 is a cross-sectional view corresponding to the line A1-A2 in FIG. 1B. As shown in FIG. 6, in the magnetic head 114 according to the embodiment, the configuration of the fourth magnetic layer 24 differs from that in the magnetic head 110. Except for this, the configuration of the magnetic head 114 may be the same as the configuration of the magnetic head 110.

As shown in FIG. 6, the fourth magnetic layer 24 may include a first magnetic film 24a, a second magnetic film 24b, and a first non-magnetic film 24c. The second magnetic film 24b is provided between the first magnetic film 24a and the second partial region 11b. The first non-magnetic film 24c is provided between the first magnetic film 24a and the second magnetic film 24b.

The first magnetic film 24a and the second magnetic film 24b may have, for example, an SAF (synthetic anti-ferromagnetic) structure. This makes it easier to obtain a more stable and stronger first signal Sg1.

The first magnetic film 24a and the second magnetic film 24b may include, for example, at least one selected from the group consisting of Fe, Co, and Ni. These magnetic films are, for example, ferromagnetic films. The first non-magnetic film 24c may include, for example, Ru.

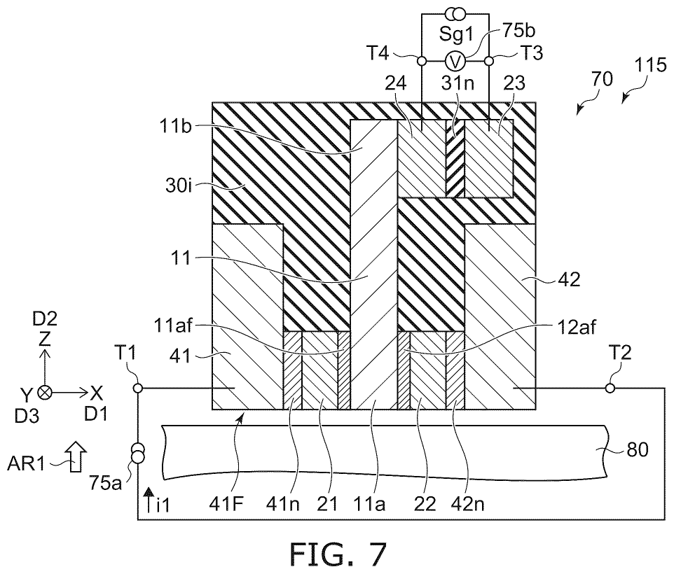

FIG. 7 is a schematic cross-sectional view illustrating a magnetic head according to the first embodiment.

FIG. 7 is a cross-sectional view corresponding to the line A1-A2 in FIG. 1B. As shown in FIG. 7, in a magnetic head 115 according to the embodiment, the reproducing section 70 further includes a first partial region film 11af. Except for this, the configuration of the magnetic head 115 may be the same as the configuration of the magnetic head 110.

The first partial region film 11af is provided between the first partial region 11a and the first magnetic layer 21, and is non-magnetic. The first partial region film 11af includes, for example, oxygen. With such a first partial region film 11af, for example, impedance matching is easily achieved. Higher sensitivity is easily achieved. The first partial region film 11af may include, for example, a CCP (current confined pass) film. With such a first partial region film 11af, for example, impedance matching is easily achieved. Higher sensitivity is easily achieved.

The reproducing section 70 may further include a second partial region film 12af. The second partial region film 12af is provided between the first partial region 11a and the second magnetic layer 22, and is non-magnetic. The second partial region film 12af includes, for example, oxygen. With such a second partial region film 12af, for example, impedance matching is easily obtained. Higher sensitivity is easily obtained. The second partial region film 12af may include, for example, a CCP film. With such a second partial region film 12af, for example, impedance matching is easily obtained. Higher sensitivity is easily obtained.

### SECOND EMBODIMENT

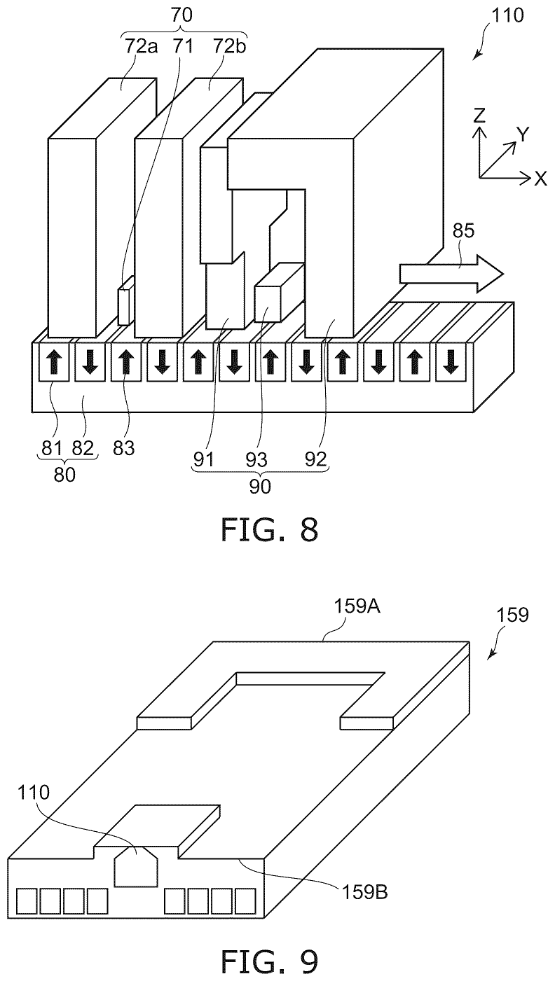

FIG. 8 is a schematic perspective view illustrating the magnetic head and magnetic recording device according to a second embodiment.

As shown in FIG. 8, a magnetic head 110 according to the embodiment includes the reproducing section 70. The magnetic head 110 is used together with the magnetic recording medium 80. In this example, the magnetic head 110 includes a recording section 90. The recording section 90 of the magnetic head 110 records information on the magnetic recording medium 80. The reproducing section 70 reproduces the information recorded on the magnetic recording medium 80.

The magnetic recording medium 80 includes, for example, a medium substrate 82 and a magnetic recording layer 81 provided on the medium substrate 82. The magnetization 83 of the magnetic recording layer 81 is controlled by the recording section 90. The recording section 90 includes, for example, a first recording section shield 91 and a second recording section shield 92. The first recording section shield 91 is, for example, a main shield. The second recording section shield 92 is, for example, a trailing shield. The recording section 90 may include a recording section element 93. The recording section element 93 may include a magnetic field control element or a high-frequency oscillation element. The recording section element 93 may be omitted.

The reproducing section 70 includes, for example, a first reproducing magnetic shield 72a, a second reproducing magnetic shield 72b, and a magnetic reproducing element 71. The magnetic reproducing element 71 is provided between the first reproducing magnetic shield 72a and the second reproducing magnetic shield 72b. The magnetic reproducing element 71 can output a signal corresponding to the magnetization 83 of the magnetic recording layer 81.

In the magnetic head 110, the first reproducing magnetic shield 72a corresponds to the first shield 41, and the second reproducing magnetic shield 72b corresponds to the second shield 42. The magnetic reproducing element 71 may correspond to a stack including, for example, the first magnetic layer 21, the first partial region 11a, and the second magnetic layer 22.

As shown in FIG. 8, the magnetic recording medium 80 moves relative to the magnetic head 110 in the medium movement direction 85. The magnetic head 110 controls information corresponding to the magnetization 83 of the magnetic recording layer 81 at arbitral position. The magnetic head 110 reproduces information corresponding to the magnetization 83 of the magnetic recording layer 81 at arbitral position. The magnetic field to be detected, as described in relation to the first embodiment, is based on the magnetization 83 of the magnetic recording medium 80.

FIG. 9 is a schematic perspective view illustrating a part of the magnetic recording device according to the embodiment.

FIG. 9 illustrates a head slider.

The magnetic head 110 is provided on the head slider 159. The head slider 159 includes, for example, Al₂O₃/TiC or the like. The head slider 159 moves relative to the magnetic recording medium while floating or in contact with the magnetic recording medium.

The head slider 159 includes, for example, an air inflow side 159A and an air outflow side 159B. The magnetic head 110 is arranged on the side face of the air outflow side 159B of the head slider 159 or the like. As a result, the magnetic head 110 moves relative to the magnetic recording medium while flying above or in contact with the magnetic recording medium.

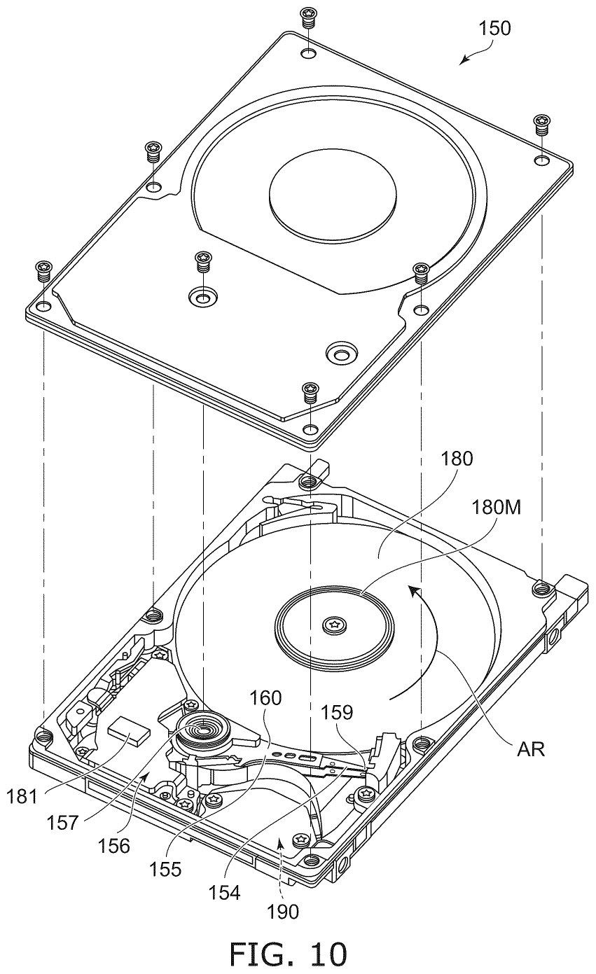

FIG. 10 is a schematic perspective view illustrating the magnetic recording device according to the embodiment.

As shown in FIG. 10, in a magnetic recording device 150 according to the embodiment, a rotary actuator is used. The recording medium disk 180 is connected to a spindle motor 180M. The recording medium disk 180 is rotated in a direction of arrow AR by the spindle motor 180M. The spindle motor 180M is responsive to control signals from the drive device controller. The magnetic recording device 150 according to the embodiment may include the multiple recording medium disks 180. The magnetic recording device 150 may include a recording medium 181. The recording medium 181 is, for example, an SSD (Solid State Drive). A non-volatile memory such as a flash memory is used for the recording medium 181, for example. For example, the magnetic recording device 150 may be a hybrid HDD (Hard Disk Drive).

The head slider 159 records and reproduces information to be recorded on the recording medium disk 180. The head slider 159 is provided at an end of a thin-film suspension 154. A magnetic head according to the embodiment is provided near the end of the head slider 159.

While the recording medium disk 180 is rotating, the pressing pressure by the suspension 154 and the floating pressure generated at the medium facing face (ABS) of the head slider 159 are balanced. The distance between the medium facing face of the head slider 159 and the face of the recording medium disk 180 is the predetermined fly height. In the embodiment, the head slider 159 may contact the recording medium disk 180. For example, a contact sliding type may be applied.

The suspension 154 is connected to one end of an arm 155 (e.g., an actuator arm). The arm 155 includes, for example, a bobbin part or the like. The bobbin part holds a drive coil. A voice coil motor 156 is provided at the other end of the arm 155. The voice coil motor 156 is a type of linear motor. The voice coil motor 156 includes, for example, a drive coil and a magnetic circuit. The drive coil is wound on the bobbin part of the arm 155. The magnetic circuit includes permanent magnets and opposing yokes. The drive coil is provided between the permanent magnet and the opposing yoke. The suspension 154 includes one end and the other end. The magnetic head is provided at one end of the suspension 154. The arm 155 is connected to the other end of the suspension 154.

The arm 155 is held by ball bearings. Ball bearings are provided at two locations above and below a bearing part 157. The arm 155 can be rotated and slid by the voice coil motor 156. The magnetic head can move to any position on the recording medium disk 180.

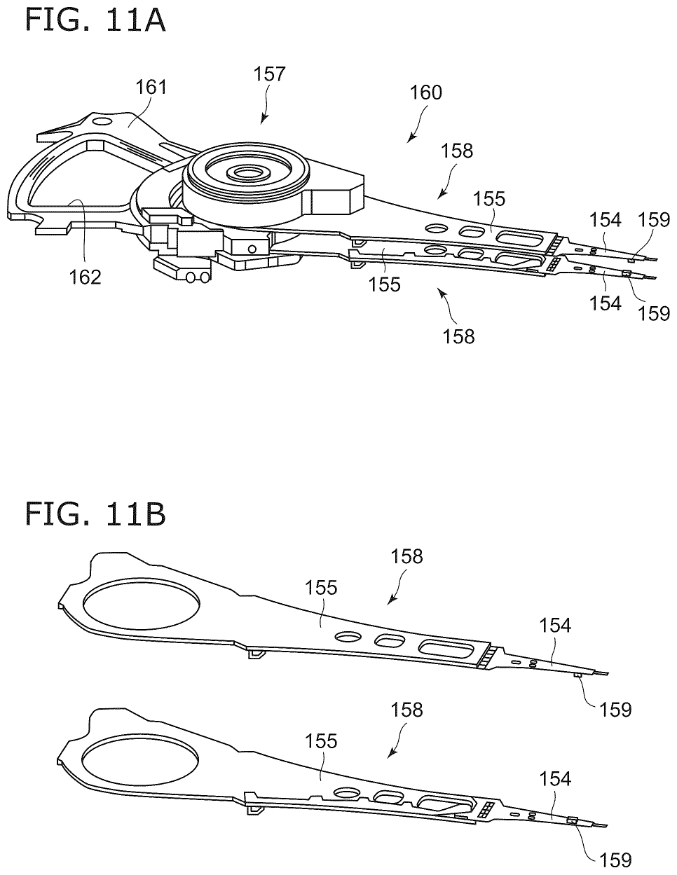

FIGS. 11A and 11B are schematic perspective views illustrating a part of the magnetic recording device according to the embodiment.

FIG. 11A is an enlarged perspective view of the head stack assembly 160, illustrating the configuration of a part of the magnetic recording device.

FIG. 11B is a perspective view illustrating the magnetic head assembly (head gimbal assembly: HGA) 158 that forms part of the head stack assembly 160.

As shown in FIG. 11A, the head stack assembly 160 includes the bearing part 157, the magnetic head assembly 158 and a support frame 161. The magnetic head assembly 158 extends from the bearing part 157. The support frame 161 extends from the bearing part 157. A direction in which the support frame 161 extends is opposite to a direction in which the magnetic head assembly 158 extends. The support frame 161 supports a coil 162 of the voice coil motor 156.

As shown in FIG. 11B, the magnetic head assembly 158 includes the arm 155 extending from the bearing part 157 and the suspension 154 extending from the arm 155.

The head slider 159 is provided at the end of the suspension 154. The head slider 159 is provided with the magnetic head according to the embodiment.

The magnetic head assembly 158 (head gimbal assembly) according to the embodiment includes the magnetic head according to the embodiment, the head slider 159 provided with the magnetic head, the suspension 154 and the arm 155. The head slider 159 is provided at one end of the suspension 154. The arm 155 is connected to the other end of the suspension 154.

The suspension 154 may include, for example, a wiring (not shown) for recording and reproducing signals. The suspension 154 may include, for example, a heater wiring (not shown) for adjusting the fly height. The suspension 154 may include a wiring (not shown) for, for example, an oscillator element or the like. These wires may be electrically connected to multiple electrodes provided on the magnetic head.

A signal processor 190 is provided in the magnetic recording device 150. The signal processor 190 uses a magnetic head to record and reproduce signals on a magnetic recording medium. Input/output lines of the signal processor 190 are connected to, for example, electrode pads of the magnetic head assembly 158 and electrically connected to the magnetic head.

The magnetic recording device 150 according to the embodiment includes the magnetic recording medium, the magnetic head according to the embodiment, a movable part, a position controller, and a signal processor. The movable part separates the magnetic recording medium from the magnetic head or makes them relatively movable while they are in contact with each other. The position controller aligns the magnetic head with a predetermined recording position on the magnetic recording medium. The signal processor records and reproduces signals on the magnetic recording medium using the magnetic head.

For example, the recording medium disk 180 is used as the above magnetic recording medium. The movable part includes, for example, the head slider 159. The position controller described above includes, for example, the magnetic head assembly 158.

The embodiments may include the following Technical proposals:

### Technical Proposal 1

A magnetic head, comprising:

a reproducing section,

the reproducing section including:

a first shield;

a second shield;

a first non-magnetic layer, the first non-magnetic layer including a first partial region and a second partial region, a second direction from the first partial region to the second partial region crossing a first direction from the first shield to the second shield, the first partial region being provided between the first shield and the second shield in the first direction;

a first magnetic layer provided between the first shield and the first partial region in the first direction;

a second magnetic layer provided between the first partial region and the second shield in the first direction;

a third magnetic layer,

a fourth magnetic layer provided between the second partial region and the third magnetic layer; and

a first intermediate layer provided between the third magnetic layer and the fourth magnetic layer, the first intermediate layer being non-magnetic.

### Technical Proposal 2

The magnetic head according to Technical proposal 1, wherein

a direction from the second partial region to the third magnetic layer is along the first direction.

### Technical Proposal 3

The magnetic head according to Technical proposal 1 or 2, wherein

at least a part of the fourth magnetic layer overlaps the first magnetic layer or the second magnetic layer in the second direction.

### Technical Proposal 4

The magnetic head according to any one of Technical proposals 1-3, wherein

at least a part of the third magnetic layer overlaps the first shield or the second shield in the second direction.

### Technical Proposal 5

The magnetic head according to any one of Technical proposals 1-4, wherein

the reproducing section further includes a third shield and a fourth shield,

a third direction from the third shield to the fourth shield crosses a plane including the first direction and the second direction, and

the first magnetic layer, the first partial region, and the second magnetic layer are between the third shield and the fourth shield in the third direction.

### Technical Proposal 6

The magnetic head according to Technical proposal 5, wherein

a part of the second partial region overlaps the third shield in the second direction.

### Technical Proposal 7

The magnetic head according to Technical proposal 6, wherein

another part of the second partial region overlaps the fourth shield in the second direction.

### Technical Proposal 8

The magnetic head according to Technical proposal 5, wherein

at least a part of the second partial region is between the third shield and the fourth shield.

### Technical Proposal 9

The magnetic head according to any one of Technical proposals 1-8, wherein

the reproducing section further includes:

a first terminal electrically connected to the first shield,

a second terminal electrically connected to the second shield,

a third terminal electrically connected to the third magnetic layer, and

a fourth terminal electrically connected to the fourth magnetic layer,

the first shield includes a first face configured to face a magnetic recording medium, and

a first signal between the third terminal and the fourth terminal when a first current flows between the first terminal and the second terminal is configured to change depending on a state of the magnetic recording medium.

### Technical Proposal 10

The magnetic head according to any one of Technical proposals 1-8, wherein

the reproducing section further includes a fifth magnetic layer, a sixth magnetic layer, and a second intermediate layer being non-magnetic,

the second partial region is between the fifth magnetic layer and the third magnetic layer,

the sixth magnetic layer is between the fifth magnetic layer and the second partial region,

the second intermediate layer is between the fifth magnetic layer and the sixth magnetic layer.

### Technical Proposal 11

The magnetic head according to Technical proposal 10, wherein

the reproducing section further includes:

a first terminal electrically connected to the first shield,

a second terminal electrically connected to the second shield,

a third terminal electrically connected to the third magnetic layer, and

a fourth terminal electrically connected to the fifth magnetic layer,

the first shield includes a first face configured to face a magnetic recording medium, and

a first signal between the third terminal and the fourth terminal when a first current flows between the first terminal and the second terminal is configured to change depending on a state of the magnetic recording medium.

### Technical Proposal 12

The magnetic head according to any one of Technical proposals 1-11, wherein

the fourth magnetic layer includes
a first magnetic film,
a second magnetic film provided between the first magnetic film and the second partial region, and
a first non-magnetic film provided between the first magnetic film and the second magnetic film.

### Technical Proposal 13

The magnetic head according to any one of Technical proposals 1-12, wherein

the first intermediate layer includes MgO or Cu.

### Technical Proposal 14

The magnetic head according to any one of Technical proposals 1-13, wherein

at least one of the first magnetic layer or the second magnetic layer includes at least one selected from the group consisting of Co₂MnAl, Co₂MnSi, Co₂MnGa, Co₂MnGe, Co₂Mn(Ge_{0.5}Ga_{0.5}), Co₂Fe(Ge_{0.5}Ga_{0.5}), and CoFeMnSi.

### Technical Proposal 15

The magnetic head according to any one of Technical proposals 1-13, wherein

at least one of the first magnetic layer or the second magnetic layer includes a Heusler alloy.

### Technical Proposal 16

The magnetic head according to any one of Technical proposals 1-15, wherein

the reproducing section further includes a first shield film provided between the first shield and the first magnetic layer, and the first shield film is non-magnetic.

### Technical Proposal 17

The magnetic head according to any one of Technical proposals 1-16, wherein

the reproducing section further includes a second shield film provided between the second shield and the second magnetic layer, and the second shield film is non-magnetic.

### Technical Proposal 18

The magnetic head according to any one of Technical proposals 1-17, wherein

the reproducing section further includes a first partial region film provided between the first partial region and the first magnetic layer, the first partial region film is non-magnetic, and the first partial region film includes oxygen.

### Technical Proposal 19

The magnetic head according to any one of Technical proposals 1-17, wherein

the reproducing section further includes a first partial region film provided between the first partial region and the first magnetic layer, the first partial region film is non-magnetic, and the first partial region film includes a CCP film.

### Technical Proposal 20

A magnetic recording device, comprising:

the magnetic head according to Technical proposal 1; and

a magnetic recording medium,

the magnetic head being configured to reproduce information recorded on the magnetic recording medium.

According to the embodiment, a magnetic head and a magnetic recording device can be provided that can improve characteristics.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in magnetic heads and magnetic recording devices such as shields, magnetic layers, non-magnetic layers, terminals, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all magnetic heads and magnetic recording devices practicable by an appropriate design modification by one skilled in the art based on the magnetic heads and the magnetic recording devices described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A magnetic head, comprising:
a reproducing section,
the reproducing section including:
a first shield;
a second shield;
a first non-magnetic layer, the first non-magnetic layer including a first partial region and a second partial region, a second direction from the first partial region to the second partial region crossing a first direction from the first shield to the second shield, the first partial region being provided between the first shield and the second shield in the first direction;
a first magnetic layer provided between the first shield and the first partial region in the first direction;
a second magnetic layer provided between the first partial region and the second shield in the first direction;
a third magnetic layer,
a fourth magnetic layer provided between the second partial region and the third magnetic layer; and
a first intermediate layer provided between the third magnetic layer and the fourth magnetic layer, the first intermediate layer being non-magnetic.

2. The magnetic head according to claim 1, wherein
a direction from the second partial region to the third magnetic layer is along the first direction.

3. The magnetic head according to claim 1, wherein
at least a part of the fourth magnetic layer overlaps the first magnetic layer or the second magnetic layer in the second direction.

4. The magnetic head according to claim 1, wherein
at least a part of the third magnetic layer overlaps the first shield or the second shield in the second direction.

5. The magnetic head according to claim 1, wherein
the reproducing section further includes a third shield and a fourth shield,
a third direction from the third shield to the fourth shield crosses a plane including the first direction and the second direction, and
the first magnetic layer, the first partial region, and the second magnetic layer are between the third shield and the fourth shield in the third direction.

6. The magnetic head according to claim 5, wherein
a part of the second partial region overlaps the third shield in the second direction.

7. The magnetic head according to claim 6, wherein
another part of the second partial region overlaps the fourth shield in the second direction.

8. The magnetic head according to claim 5, wherein
at least a part of the second partial region is between the third shield and the fourth shield.

9. The magnetic head according to claim 1, wherein
the reproducing section further includes:
a first terminal electrically connected to the first shield,
a second terminal electrically connected to the second shield,
a third terminal electrically connected to the third magnetic layer, and
a fourth terminal electrically connected to the fourth magnetic layer,
the first shield includes a first face configured to face a magnetic recording medium, and
a first signal between the third terminal and the fourth terminal when a first current flows between the first terminal and the second terminal is configured to change depending on a state of the magnetic recording medium.

10. The magnetic head according to claim 1, wherein
the reproducing section further includes a fifth magnetic layer, a sixth magnetic layer, and a second intermediate layer being non-magnetic,
the second partial region is between the fifth magnetic layer and the third magnetic layer,
the sixth magnetic layer is between the fifth magnetic layer and the second partial region,
the second intermediate layer is between the fifth magnetic layer and the sixth magnetic layer.

11. The magnetic head according to claim 10, wherein
the reproducing section further includes:
a first terminal electrically connected to the first shield,
a second terminal electrically connected to the second shield,
a third terminal electrically connected to the third magnetic layer, and
a fourth terminal electrically connected to the fifth magnetic layer,
the first shield includes a first face configured to face a magnetic recording medium, and
a first signal between the third terminal and the fourth terminal when a first current flows between the first terminal and the second terminal is configured to change depending on a state of the magnetic recording medium.

12. The magnetic head according to claim 1, wherein
the fourth magnetic layer includes
a first magnetic film,
a second magnetic film provided between the first magnetic film and the second partial region, and
a first non-magnetic film provided between the first magnetic film and the second magnetic film.

13. The magnetic head according to claim 1, wherein the first intermediate layer includes MgO or Cu.

14. The magnetic head according to claim 1, wherein
at least one of the first magnetic layer or the second magnetic layer includes at least one selected from the group consisting of Co₂MnAl, Co₂MnSi, Co₂MnGa, Co₂MnGe, Co₂Mn(Ge_{0.5}Ga_{0.5}), Co₂Fe(Ge_{0.5}Ga_{0.5}), and CoFeMnSi.

15. The magnetic head according to claim 1, wherein
at least one of the first magnetic layer or the second magnetic layer includes a Heusler alloy.

16. The magnetic head according to claim 1, wherein
the reproducing section further includes a first shield film provided between the first shield and the first magnetic layer, and the first shield film is non-magnetic.

17. The magnetic head according to claim 1, wherein
the reproducing section further includes a second shield film provided between the second shield and the second magnetic layer, and the second shield film is non-magnetic.

18. The magnetic head according to claim 1, wherein
the reproducing section further includes a first partial region film provided between the first partial region and the first magnetic layer, the first partial region film is non-magnetic, and the first partial region film includes oxygen.

19. The magnetic head according to claim 1, wherein
the reproducing section further includes a first partial region film provided between the first partial region and the first magnetic layer, the first partial region film is non-magnetic, and the first partial region film includes a CCP film.

20. A magnetic recording device, comprising:
the magnetic head according to claim 1; and
a magnetic recording medium,
the magnetic head being configured to reproduce information recorded on the magnetic recording medium.
